(19) United States
(12) Patent Application Publication
(10) Pub. No.: US 2025/0057343 A1
(43) Pub. Date: Feb. 20, 2025

(54) BIODEGRADABLE DISPOSABLE ARTICLES

(71) Applicant: TerraSafe Materials, Inc., State College, PA (US)

(72) Inventors: Andrea Epifani, Brisbane, Queensland (AU); Shafali Gupta, Brisbane, Queensland (AU)

(73) Assignee: TerraSafe Materials, Inc., State College, PA (US)

(21) Appl. No.: 18/722,912

(22) PCT Filed: Dec. 21, 2022
(86) PCT No.: PCT/AU2022/051551

§ 371 Date: Jun. 21, 2024

(30) Foreign Application Priority Data
Dec. 21, 2021 (AU) 2021904175

(51) Int. Cl. A47G 19/03; B09B 3/32; B09B 3/35; B09B 3/38; B09B 3/40; B09B 101/70; C08L 1/02; C08L 5/06; C08L 5/14; C08L 97/00

(52) U.S. Cl. CPC A47G 19/03; B09B 3/32; B09B 3/35; B09B 3/38; B09B 3/40; C08L 1/02; C08L 5/06; C08L 5/14; C08L 97/00; B09B 2101/70; C08L 2201/06; C08L 2205/035

(57) ABSTRACT

The present invention relates to a biodegradable disposable article comprising: unmodified and naturally occurring food waste comprising cellulose or hemicellulose in the range of about 5 wt % to about 70 wt %, less than about 80 wt % carbohydrate and at least about 2 wt % of lignin; wherein the food waste is optionally dehydrated and/or optionally agitated to form particulate solid material before being moulded under pressure of at least 5000 kg/cm² and at a temperature of at least 150° C.

### TECHNICAL FIELD

The present invention relates to biodegradable disposable articles and a method of making biodegradable disposable articles.

BACKGROUND

Any references to methods, apparatus or documents of the prior art are not to be taken as constituting any evidence or admission that they formed, or form part of the common general knowledge.

Standard disposable plastic tableware, utensils, and single-use plastic articles have a number of drawbacks. These articles are typically not biodegradable, and are made from nonbiodegradable plastics (such as polyethylene, polypropylene, polystyrene, and polyurethane). These nonbiodegradable plastics are now used extensively in place of metal and paper products for many applications, especially those where cost, durability, ease of manufacturing, availability of material and convenience are major considerations. One of the biggest problems with these plastics, however, is with disposal, since they have very low rates of degradation, if any.

In more recent times, biodegradable polymers have been developed for manufacturing disposable tableware, utensils, and single-use plastic articles. These biodegradable polymers degrade by enzymatic or hydrolytic. Some of the more commonly known biodegradable polymers include poly (glycolic acid), poly (lactic acid) and copolymers thereof, polycaprolactone, poly (hydroxybutyrate), starch and cellulose. However, one of the main concerns around using these materials for applications such as disposable utensils and tableware is the high costs associated with the production of these biodegradable polymers. In some instances, it is also difficult to tailor mechanical properties of these biodegradable polymers for use in producing disposable tableware and utensils. These concerns are equally applicable to packaging.

It is therefore desirable to consider the use of alternative sources such as biodegradable food waste for producing disposable utensils and tableware which would potentially reduce the cost of production of such biodegradable moulded articles like utensils and tableware.

It would be advantageous to address one or more of the above issues and/or at least provide the consumer with a useful or commercial alternative.

### SUMMARY OF INVENTION

In a first aspect, although it need not be the only or indeed the broadest aspect, the invention resides in a biodegradable disposable article comprising: unmodified and naturally occurring food waste comprising cellulose or hemicellulose in the range of about 5 wt % to about 70 wt %, less than about 80 wt % carbohydrate and at least about 2 wt % of lignin; wherein the food waste is optionally dehydrated and/or agitated to form particulate solid material before being moulded under pressure of at least about 5000 kg/cm² and at a temperature of at least 150° C.

In one embodiment, the cellulose is present in a range of less than 60%, between about 5% and about 50%, between about 5% and about 30%, between about 5% and about 25%, between about 8% and about 26%, or between about 5% and about 22%

In certain embodiments, the carbohydrate is a soluble carbohydrate comprising pectin. In one embodiment, the soluble carbohydrate is present in a range of less than about 30%, between about 1% and about 30%, In an embodiment, the soluble carbohydrate is present in a range of between about 1% and about 10%, or between about 3% and about 8%. In certain embodiments, the soluble carbohydrate is present in a range of between about 10% and about 30%, between about 14% and about 25%, between about 15% and about 30%, or between about 15% and about 27%.

In an embodiment, lignin is present in a range of between about 1% to 30%, between about 1% and about 26%, between about 1% and about 25%, between about 2% and about 7%, or between about between about 3% and about 6%

In some embodiments, the food waste further comprises protein in a range between about 1% and about 20% In one embodiment, the protein is present in a range between about 1% and about 10%, between about 2% and about 10%, or between about 3% to about 10%. In certain embodiments, the protein is present in a range between about 10% and about 20%, or between about 13% and about 19%.

In an embodiment, the food waste further comprises fat in a range of at least 1%, between about 1% and about 15%, between about 1% and about 12%, or between about 1% and about 11%. In one embodiment, the fat is present in a range of between about 1% and about 5%, or between about 1% and about 4%. In one embodiment, the fat is present in a range of between about 4% and about 12%, between about 4% and about 11%. In one embodiment, the fat is crude fat.

In embodiments, the food waste has a ADF content of at least about 9%, or at least about 10%, between about 10% and about 50%, between about 10% and about 25%, between about 10% to about 20%, or between about 40% and about 50%

In an embodiment, the particulate solid material is placed in a pre-heated mould heated to a temperature of at least 150° C.

In an embodiment, the food waste comprises hemicellulose in an amount of at least about 5wt %, less than about 60%, less than about 50% or less than about 40%, between about 0% and about 60% hemicellulose, between about 20% and about 60%, between about 25% and about 60%, or between about 10% and about 40%.

In an embodiment, the particulate solid material is moulded under pressure in the range of between about 5000 kg/cm² and about 1000000 kg/cm², between about 5000 kg/cm² and about 100000 kg/cm², between about 20000 kg/cm² and about 1000000 kg/cm², or between about 20000 kg/cm² to about 100000 kg/cm².

In an embodiment, the particulate solid material is moulded for at least 1 second and preferably at least 10 seconds.

In an embodiment, the particulate solid material is moulded at a temperature in the range of between about 150° C. and about 300° C., or in the range of about 200° C. and about 300° C.

In an embodiment, the naturally occurring food waste comprises one or more of the following: citrus peel, avocado seed, pineapple skin, pineapple top, wheat bran, coffee husk, spent coffee ground, and barley bran. In an embodiment, the citrus peel comprises orange peel and/or lemon peel.

In an embodiment, the food waste has a moisture content of less than about 2%, or between 0.1% and about 1%. In one embodiment, the food waste is dehydrated to have a moisture content of less than about 2%, or between 0.1% and about 1%

In some embodiments, the food waste comprises:
cellulose in an amount of between about 5% and about 30%;
soluble carbohydrates comprising pectin in an amount of between about 1% and about 30%;
protein in an amount of between about 1% and about 20%;
fat in an amount of between about 1% and about 15%.

In certain embodiments, the food waste comprises:
cellulose in an amount of between about 5% and about 25%;
soluble carbohydrates comprising pectin in an amount of between about 10% and about 30%;
protein in an amount of between about 1% and about 10%;
fat in an amount of between about 1% and about 5%.

In embodiments, the food waste comprises:
cellulose in an amount of between about 5% and about 26%;
soluble carbohydrates comprising pectin in an amount of between about 1% and about 10%;
protein in an amount of between about 10% and about 20%;
fat in an amount of between about 4% and about 11%.

In a second aspect, the invention resides in a method forming a biodegradable disposable article, the method comprising:
collecting unmodified and naturally occurring food waste comprising cellulose and/or hemicellulose in the range of about 5 wt % to about 70 wt %, less than about 80 wt % carbohydrate and at least about 2 wt % of lignin;
optionally heating and dehydrating the food waste to obtain dehydrated or dried food waste; and
placing said particulate solid material in a mould wherein the mould is subjected to a temperature of at least 150° C. and applying pressure of at least 20 kg/cm₂ to the mould.

In one embodiment, the method further includes the step of optionally agitating or pulverizing the dried food waste to form particulate solid material. In an embodiment, the method further includes the step of agitating or pulverizing the dried food waste to form particulate solid material.

In a third aspect, the invention resides in a method of forming a biodegradable disposable article, the method comprising:
collecting unmodified and naturally occurring food waste comprising cellulose or hemicellulose in the range of about 5 wt % to about 70 wt %, less than about 80 wt % carbohydrate and at least about 2 wt % of lignin;
optionally heating and dehydrating the food waste to obtain dehydrated or dried food waste;
agitating or pulverizing the dried food waste to form particulate solid material; and
placing said particulate solid material in a mould wherein the mould is subjected to a temperature of at least 150° C. and applying pressure of at least 5000 kg/cm² to the mould.

The method, and food waste and components thereof, described in the second and third aspects are as substantially described for the first aspect.

### DETAILED DESCRIPTION OF PREFERRED EMBODIMENTS

Embodiments of the present invention reside primarily in a biodegradable disposable article. Accordingly, the article and method steps have been illustrated in concise schematic form in the drawings, showing only those specific details that are necessary for understanding the embodiments of the present invention, but so as not to obscure the disclosure with excessive detail that will be readily apparent to those of ordinary skill in the art having the benefit of the present description.

Polysaccharide-based materials that form part of food waste have been utilized by the novel method of the present invention. Polysaccharide containing food waste have a continuous hydrophobic polysaccharide phase and a discontinuous phase of dispersed hydrophilic unmodified polysaccharide or bicontinuous phases of both. These materials are substantially biodegradable and thermoplastic, and thus may be molded into a variety of articles of manufacture which will decompose in the environment after use.

The term “polysaccharide” refers to a material of the formula (C₆ H₁₀ O₅) n. The term “starch” is typically applied to a carbohydrate produced by plants containing amylose and/or amylopectin. Amylose is the mainly unbranched type of starch, which generally consists of glucose residues in α-1,4 linkages. Amylopectin is the branched form, and has roughly one α-1,6 linkage for every thirty α-1,4-linkages. Both amylose and amylopectin are rapidly hydrolyzed by enzymes called a-amylases. Starch occurs as organized or structural granules of varying size or markings in many plant cells and hydrolyzes to several forms of dextrin and glucose.

As used herein, “thermoplastic” refers to a material that softens when heated and hardens when cooled; and “melt process” refers to the processing of thermoplastic materials in their softened state into useful articles.

Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus

As used herein, the term ‘about’ means the amount is nominally the number following the term ‘about’ but the actual amount may vary from this precise number to an unimportant degree.

The term ‘hydrophobic’, as used herein, refers to a material that absorbs 5% or less its weight of water when immersed in water under ambient conditions. The term hydrophilic, as used herein, refers to a material that absorbs greater than 5% water when immersed in water under ambient conditions.

As used herein, the % refers to % wt unless otherwise specified.

The present invention is predicated on the finding that, at least, suitable biodegradable disposable articles can be formed from food compositions. For ease of description, the present description has been described in relation to food wastes. However, it will be appreciated that non-food waste compositions can be utilized in the present invention. In an embodiment, the food waste is unmodified and naturally occurring food waste. In an embodiment, the method further includes the step of agitating or pulverizing the dried food waste to form particulate solid material.

Through extensive trials and experiments, the inventors have surprisingly discovered that food waste satisfying a criteria of containing cellulose or hemicellulose in the range of 5 wt % to 70 wt %, less than 80 wt % carbohydrate and at least 2 wt % of pectin and/or lignin appear to be readily moulded into biodegradable utensils when processed in accordance with a novel sequence of process steps.

Depending on the requirements of the biodegradable disposable articles, the inventors have found that food waste falling within certain criteria can be formed into useful biodegradable disposable articles. In this regard, through extensive testing, the results suggest that some food waste can be utilized for liquids (such a cups, bowls and the like) and other food waste can be used for packaging (not necessarily with liquids).

In one embodiment, the cellulose is present in a range of less than 60%, between about 5% and about 50%, between about 5% and about 30%, between about 5% and about 25%, between about 8% and about 26%, or between about 5% and about 22%

In certain embodiments, the carbohydrate is a soluble carbohydrate comprising pectin. In one embodiment, the soluble carbohydrate is present in a range of less than about 30%, between about 1% and about 30%, In an embodiment, the soluble carbohydrate is present in a range of between about 1% and about 10%, or between about 3% and about 8%. In certain embodiments, the soluble carbohydrate is present in a range of between about 10% and about 30%, between about 14% and about 25%, between about 15% and about 30%, or between about 15% and about 27%. In one embodiment, the soluble carbohydrate predominantly comprises pectin. In one embodiment, the soluble carbohydrate is pectin.

In an embodiment, lignin is present in a range of between about 1% to 30%, between about 1% and about 26%, between about 1% and about 25%, between about 2% and about 7%, or between about between about 3% and about 6%

In some embodiments, the food waste further comprises protein in a range between about 1% and about 20% In one embodiment, the protein is present in a range between about 1% and about 10%, between about 2% and about 10%, or between about 3% to about 10%. In certain embodiments, the protein is present in a range between about 10% and 20%, or between about 13% and about 19%.

In an embodiment, the food waste further comprises fat in a range of at least 1%, between about 1% and about 15%, between about 1% and about 12%, or between about 1% and about 11%. In one embodiment, the fat is present in a range of between about 1% and about 5%, or between about 1% and about 4%. In one embodiment, the fat is present in a range of between about 4% and about 12%, between about 4% and about 11% In an embodiment, the fat is crude fat.

Acid detergent fibre (ADF) is the residue remaining after extraction with hot acid detergent solutions. Typically, the ADF includes lignin and cellulose, but does not contain hemicellulose. In embodiments, the food waste has an ADF content of at least about 9%, or at least about 10%, between about 10% and about 50%, between about 10% and about 25%, between about 10% to about 20%, or between about 40% and 50%.

Neural detergent fibre (NDF) is the residue remaining after extraction with a neutral detergent solution. Typically, NDF includes lignin, cellulose, and hemicellulose. The main difference between NDF and ADF is the hemicellulose content.

In an embodiment, the particulate solid material is placed in a pre-heated mould heated to a temperature of at least 150° C.

In an embodiment, the food waste comprises hemicellulose in an amount of at least about 5 wt %, less than about 60%, less than about 50% or less than about 40%, between about 0% and about 60% hemicellulose, between about 20% and about 60%, between about 25% and about 60%, or between about 10% and about 40%.

In an embodiment, the particulate solid material is moulded under pressure in the range of between about 5000 kg/cm² and about 1000000 kg/cm², between about 5000 kg/cm² and about 100000 kg/cm², between about 20000 kg/cm² and about 1000000 kg/cm², or between about 20000 kg/cm² to about 100000 kg/cm².

In an embodiment, the particulate solid material is moulded for at least 1 second and preferably at least 10 seconds.

In an embodiment, the particulate solid material is moulded at a temperature in the range of between about 150° C. and about 300° C., or in the range of about 200° C. and about 300° C.

In an embodiment, the naturally occurring food waste comprises one or more of the following: citrus peel, avocado seed, pineapple skin, pineapple top, wheat bran, coffee husk, spent coffee ground, and barley bran. In an embodiment, the citrus peel comprises orange peel and/or lemon peel.

In an embodiment, the food waste has a moisture content of less than about 2%, or between 0.1% and about 1%. In one embodiment, the food waste is dehydrated to have a moisture content of less than about 2%, or between 0.1% and about 1%. It will be appreciated that the food waste need not necessarily be dehydrated if the moisture content is within the desired range.

In some embodiments, the food waste comprises:
cellulose in an amount of between about 5% and about 30%;
soluble carbohydrates comprising pectin in an amount of between about 1% and about 30%;
protein in an amount of between about 1% and about 20%;
fat in an amount of between about 1% and 15%.

The results from the testing suggests that a biodegradable disposable article formed a food waste as follows has extremely advantageous properties in relation to water absorption properties. In this regard, the results suggest that biodegradable disposable articles formed from the food waste is suitably for use with liquids (such as cups and bowls). In embodiments, the food waste comprises:
cellulose in an amount of between about 5% and about 30%;
soluble carbohydrates comprising pectin in an amount of between about 1% and about 10%;
protein in an amount of between about 10% and about 20%;
fat in an amount of between about 4% and about 11%.

In a preferred embodiment, the food waste comprises:
cellulose in an amount of between about 8% and about 26%;
soluble carbohydrates comprising pectin in an amount of between about 3% and about 8%;
protein in an amount of between about 13% and about 19%;
fat in an amount of between about 4% and about 11%.

In a further embodiment, the food waste further comprises hemicellulose in an amount of between about 5% and about 50%, between about 10% and about 40%, or between about 11% and about 40%.

The results from the testing suggests that a biodegradable disposable article formed a food waste as follows has sufficient properties in relation to water absorption for use as packaging and similar products. In an embodiment, the food waste comprises:
cellulose in an amount of between about 5% and about 25%;
soluble carbohydrates comprising pectin in an amount of between about 10% and about 30%;
protein in an amount of between about 1% and about 10%;
fat in an amount of between about 1% and about 5%.

In a preferred embodiment, the food waste comprises:
cellulose in an amount of between about 5% and about 22%;
soluble carbohydrates comprising pectin in an amount of between about 15% and about 28%;
protein in an amount of between about 3% and about 10%;
fat in an amount of between about 1% and about 4%.

In a further embodiment, the food waste further comprises hemicellulose in an amount of between about 0% and about 60%, between about 0% and about 56%, between about 25% and about 56%, or between about 25% and about 26%.

Specifically, the inventors have found that the food waste satisfying the above-mentioned criteria may be initially dehydrated and then optionally subjected to an agitation or pulverization step to break down the dehydrated food waste into particulate solid material to preferably attain a non-limiting average particle size in the range of about 0.01 mm to about 1 mm. In one embodiment, the average particle size of the dehydrated food waste is in the range of between 0.01 mm and about 1 mm, between about 0.1 mm and about 1 mm, or in the range of about 0.3 mm and about 0.5 mm. Any larger particulates or aggregates may be removed by using a separation step by using a sieve or any other relevant method. Herein, it should be understood that the method of dehydration or agitation is not dependent on any specific dehydration or agitation steps and the specific technique adopted may depend on the characteristics of the food waste satisfying the above-mentioned initial composition criteria.

Once, optionally, substantially uniform particle size has been achieved by the agitation step, the dehydrated food waste particles are placed in a mould that has been heated at least to a temperature of about 150° C. As will be evident in the foregoing examples, the mould temperature may be varied and increased for at least some non-limiting embodiments. Once the particulate solid food waste is placed in the pre-heated mould, the particles are pressed in a mould with pressure in the range of about 5000 to about 100000 kg/cm² is applied for at least 1 sec. In the experiments pressing was required for relatively short time periods such as 30 seconds.

Polysaccharides make up the bulk of the food waste being processed and they are chains of monosaccharide units joined by glycosidic bonds. They are the most abundant form of carbohydrates. Some of the most common types are cellulose, starch, glycogen, and pectin. Glucose units in cellulose are linked with ß 1-4 glycosidic bonds and glucose units in starch are linked by a 1-4 or a 1-6 glycosidic bonds. Pectin is a unique fibre that is found in fruits and vegetables; it has a linear shape that contains a galacturonic acid molecule connected with a glycosidic bond. When heated in the presence of a liquid, the polysaccharides in the presently described embodiments expand and form a gel.

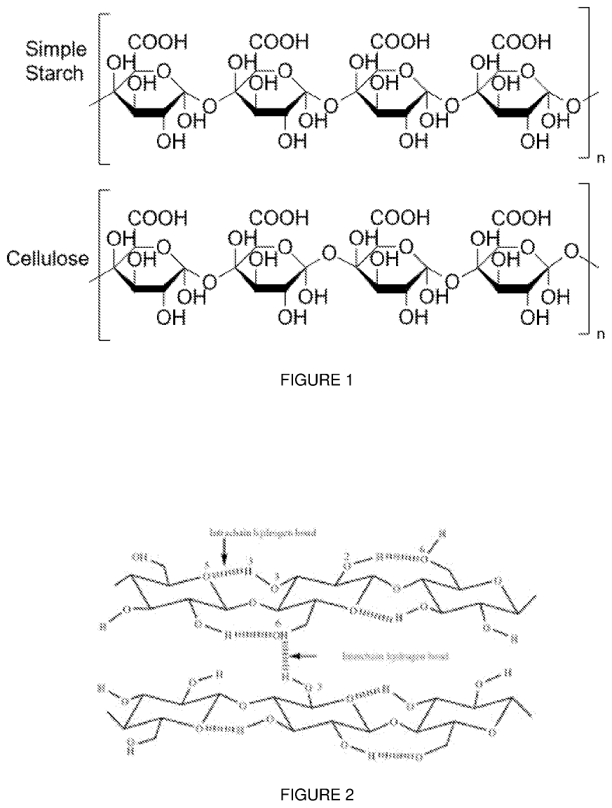

Monomeric glucose units are connected in different ways in different types of polysaccharides. When polysaccharides come into contact with water, the glycosidic bond breaks (shown in pink and purple in FIG. 1). The oxygen atom reacts with the water molecule and causes the molecules to leach/degrade. This event is called hydrolysis as has been defined in the earlier sections.

Due to the presence of a CO₂H (carboxylic group), pectin is an acid while lignin is an alcohol. Pectin, as an acid, is more reactive than alcohol. Lignin has an additional alkyl chain which you can see in the image below highlighted by alpha, beta, gamma groups. The presence of hydroxyl group on the alkyl chain makes it more stable with starch and cellulose when it comes into contact with water and heat. Due to this effect, when food waste containing coffee husk, coffee ground, and wheat bran are processed in accordance with the novel method of the present invention, the biodegradable articles are very stable and have low reactivity with water which makes them suitable for use as disposable and biodegradable utensils.

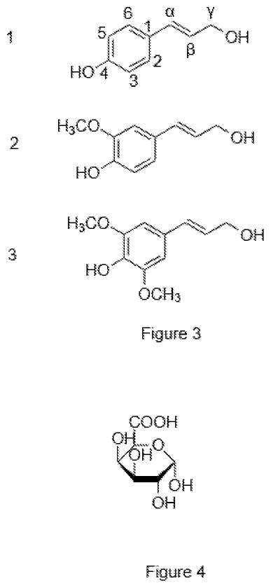

The presence of either pectin (FIG. 3) or lignin (FIG. 4) in an amount of at least 2 wt % is important. The similarity between pectin and lignin is their hydroxyl group reacts in the similar manner as starch and cellulose.

The following examples detail the processing of specific types of food waste that fulfill the above-mentioned criteria of comprising cellulose and/or hemicellulose in the range of 5 wt % to 70 wt %, less than 80wt % carbohydrate and at least 2 wt % of pectin and/or lignin.

### EXAMPLES

Example 1: Making eco-friendly, biodegradable tableware out of Coffee Husk, Coffee grounds, Pineapple top, Pineapple skin, Avocado seeds, Lemon peels.

Seven types of different organic food waste products were processed as follows (shown in Table 1).

A processing step involves one or more of the following steps: Cleaning the waste with water, slicing it in the grinder, and then drying it in a dehydrator at 70° C.

TABLE 1

| | | | Drying |
|---|---|---|---|
| | Source | Procedure | time |
| 1) | Avocado pits | Wash | 5 h |
| | | Slice | |
| | | Dehydrate | |
| 2) | Pineapple skin | Wash | 24 h+ |
| | | Separate the green off the tops | |
| | | Dehydrate | |
| 4) | Orange peels | Squeeze further | 24 h+ |
| | | Dehydrate | |
| 5) | Coffee husk | Pack | N/A |
| 6) | Lemon peel | Squeeze further | 24 h+ |
| | | Dehydrate | |
| 7) | Coffee ground | Squeeze further | 24 h+ |
| | | Dehydrate | |

Example 2: Making eco-friendly, biodegradable edible tableware out of Wheat Bran

Procedure: The wheat bran (WB) was sourced from a supplier and ground for 2 minutes at 32,000 RPM. The powder was then placed into a mould and pressed for 30 seconds with a pressure of 50000 kg/cm². The resulting article was examined and tested as described below.

Microwave proof testing: 450 W for 1 min

Oven safe testing: 100° C. for 1 min

Semi-liquid testing: 2 hours

Water testing: 40 min

TABLE 2

| | | | Microwave | Oven | | |
|---|---|---|---|---|---|---|
| | Composition | Temperature | proof | safe | Semi-liquid | Water |
| 1) | WB | 200° C. | yes | yes | No leaching | Absorbs water |
| | | | | | | in 30 min |
| 2) | WB | 300° C. | yes | yes | No leaching | Absorbs water |
| | | | | | | in 30 min |
| 3) | WB | 250° C. | yes | yes | No leaching | Absorbs water |
| | | | | | | in 35 min |
| 4) | WB | 220° C. | yes | yes | No leaching | Absorbs water |
| | | | | | | in 30 min |
| 5) | WB + 5% | 250° C. | The | 30 | No leaching | Absorbs water |
| | Jaggery | | structure | seconds | | in 20 min |
| | | | becomes | later, it | | |
| | | | unstable | becomes | | |
| | | | after 30 | unstable | | |
| | | | seconds at | | | |
| | | | 900 W | | | |
| 6) | WB + 5% | 220° C. | The | Within 30 | No leaching | Absorbs water |
| | Jaggery | | structure | sec, it | | in 20 min |
| | | | becomes | becomes | | |
| | | | unstable | wobbly | | |
| | | | after 30 | | | |
| | | | seconds at | | | |
| | | | 900 W | | | |

As detailed above, in some experiments jaggery was added as a binder and the moulding temperature varied from 200°° C. to 300° C.

The results from Example 2 confirm that biodegradable utensils formed from Wheat Bran are microwave and oven safe unless combined with binding material. Tomato Sauce was used to test leaching properties of the utensil and no leaching was observed for up to 2 hours. With water, the utensils started to degrade after 20-35 minutes, with Sample 3 pressed at 250° C. lasting the longest. It is evident that for use with dry foods and semi-liquid materials such as thick soups, utensils moulded in accordance with the steps outlined for Example 1 are suitable for use.

Example 3: Raw materials were mixed with binding materials, if needed, and ground for two minutes at 32,000 RPM.

As part of this experiment, 30 g of powder was placed into a preheated mould at 150-300° C., pressed at a pressure of 50000 kg/cm² for 30 seconds, and then the resulting utensil or tableware was examined and tested under the following conditions:

Microwave proof testing: 450 W for 1 min

Oven safe testing: 100° C. for 1 min

Semi-liquid testing: 2 hours

Water testing: 40 min

TABLE 3

| | | | Microwave | | Semi- | |
|---|---|---|---|---|---|---|
| | Composition | Temperature | proof | Oven safe | liquid | Water |
| 1) | Lemon peels | 200° C. | yes | yes | No | Absorbs water |
| | | | | | leaching | in 25 min |
| 2) | Lemon peels | 150° C. | yes | yes | No | Absorbs water |
| | | | | | leaching | in 25 min |
| 3) | Lemon peels + | 200° C. | yes | 30 seconds | No | Absorbs water |
| | 5% Jaggery | | | later, it | leaching | in 19 min |
| | | | | becomes | | |
| | | | | unstable | | |
| 4) | Avocado | 200° C. | yes | yes | No | Absorbs water |
| | seeds | | | | leaching | in 10 min |
| 5) | Pineapple top | 250° C. | yes | yes | No | Absorbs water |
| | | | | | leaching | in 4 min |
| 7) | Pineapple skin | 200° C. | yes | yes | No | Absorbs water |
| | | | | | leaching | in 4 min |
| 8) | Coffee husk | 300° C. | yes | yes | No | No leaching |
| | | | | | leaching | |
| 9) | Coffee ground | 300° C. | yes | yes | No | No leaching |
| | | | | | leaching | |

All the different organic food waste materials tested during this experiment were found to be capable of deforming and reforming their shape under heat and pressure, even though they were composed of different amounts of polysaccharide with varying compositions.

Table 4 shows the compositional characteristics of the major food waste materials that were used in the Examples discussed in the earlier sections.

TABLE 4

| | | | | | Soluble | | | | Acid |
|---|---|---|---|---|---|---|---|---|---|
| | Neutral | | | | Carbohydrates | | Crude | | detergent |
| | Detergent Fibre | Cellulose | Lignin | Hemicellulose | (wt % glucose | | Fat | Starch | fibre |
| Material | (NDF; wt %) | (wt %) | (wt %) | (wt %) | equivalents) | Protein | (wt %) | (wt %) | (wt %) |
| Lemon peel | 17.23 | 12.60 | 5.18 | 0.00 | 21.80 | 7.36 | 2.82 | 0.19 | 17.79 |
| Orange peels | 15.49 | 11.85 | 5.01 | 0.00 | 22.32 | 8.10 | 1.77 | 0.15 | 15.55 |
| Avocado pits | 86.18 | 5.40 | 5.00 | 55.78 | 15.08 | 3.66 | 3.40 | 28.71 | 10.40 |
| pineapple top | 53.67 | 21.17 | 3.30 | 29.20 | 18.02 | 9.12 | 2.39 | 13.25 | 24.47 |
| Pineapple skin | 42.57 | 13.40 | 3.46 | 25.71 | 27.13 | 7.46 | 1.77 | 0.44 | 16.85 |
| Coffee ground | 76.19 | 25.42 | 23.49 | 27.28 | 3.73 | 13.88 | 13.92 | 0.15 | 48.91 |
| Wheat bran | 50.77 | 8.21 | 3.13 | 39.44 | 7.91 | 16.33 | 4.15 | 23.17 | 11.34 |
| Coffee husk | 55.93 | 19.72 | 25.04 | 11.17 | 2.68 | 16.22 | 4.78 | 0.47 | 44.76 |
| Barley bran | 46.82 | 12.23 | 6.21 | 28.40 | 6.42 | 18.68 | 5.16 | 18.59 | 18.42 |
| Wheat Bran | 49.11 | 9.21 | 3.29 | 36.60 | 7.80 | 16.99 | 4.61 | 18.33 | 12.51 |

It will be appreciated that the time for water absorption and semi-liquid leaching will be dependent on the thickness of the article. In this regard, a thicker article will be able to withstand a longer timeframe with water and semi-liquids prior to losing structural integrity.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A biodegradable disposable article comprising: unmodified and naturally occurring food waste comprising hemicellulose in an amount of less than about 60%, cellulose is present in a range of between about 5% and about 30%, and, less than 30 wt % soluble carbohydrate and at least about 2 wt % of lignin; wherein the food waste is optionally dehydrated and agitated to form particulate solid material having a particle size in the size range of 0.1 mm to 1 mm before being moulded under pressure of at least about 5000 kg/cm² and at a temperature of at least 150° C.

2. A method of forming a biodegradable disposable article, the method comprising the steps of:
collecting unmodified and naturally occurring food waste comprising hemicellulose in an amount of less than about 60%, cellulose is present in a range of between about 5% and about 30%, and less than 30 wt % soluble carbohydrate and at least about 2 wt % of lignin;
optionally heating and/or dehydrating the food waste to obtain dehydrated or dried food waste;
agitating or pulverizing the dried food waste to form particulate solid material having a particle size in the size range of 0.1 mm to 1 mm; and
placing said particulate solid material in a mould wherein the mould is subjected to a temperature of at least 150° C. and applying pressure of at least 20 kg/cm² to the mould.

3. The biodegradable disposable article of claim 1, wherein the cellulose is present in a range between about 5% and about 25%.

4. The biodegradable disposable article of claim 1, or wherein the soluble carbohydrate comprising pectin.

5. The biodegradable disposable article of claim 1, wherein the soluble carbohydrate is present in a range of about 1% and about 30%.

6. The biodegradable disposable article of claim 1, wherein the soluble carbohydrate is present in a range of between about 1% and about 10%.

7. The biodegradable disposable article of claim 1, wherein the soluble carbohydrate is present in a range of between about 10% and about 30%.

8. The biodegradable disposable article of claim 1, wherein lignin is present in a range of between about 2% to 30%.

9. The biodegradable disposable article of claim 1, wherein the food waste further comprises protein in a range between about 1% and about 20%.

10. The biodegradable disposable article of claim 7, wherein the food waste further comprises protein in a range between about 1% and about 10%.

11. The biodegradable disposable article of claim 6, wherein the food waste further comprises protein in a range between about 10% and 20%.

12. The biodegradable disposable article of claim 1, wherein the food waste further comprises fat in a range of at least 1%.

13. The biodegradable disposable article of claim 7, wherein the food waste further comprises fat in a range of between about 1% and about 5%.

14. The biodegradable disposable article of claim 6, wherein the food waste further comprises fat in a range of between about 4% and about 12%.

15. The biodegradable disposable article of claim 1, wherein the food waste has a ADF content of at least about 9%.

16. The the method of claim 2 wherein the particulate solid material is placed in a pre-heated mould heated to a temperature of at least 150° C.

17. The biodegradable disposable article of claim 1, wherein the food waste comprises hemicellulose in an amount of less than about 50%. cm 18. The the method of claim 2 wherein the particulate solid material is moulded under pressure in the range of between about 5000 kg/cm² and about 1000000 kg/cm².

19. The the method of claim 2 wherein the particulate solid material is moulded at a temperature in the range of 150° C. and about 300° C.

20. The the method of claim 2 wherein the particulate solid material is moulded for at least 1 second.

21. The biodegradable disposable article of claim 1, wherein the naturally occurring food waste comprises one or more of the following: citrus peel including orange peel and lemon peel, avocado seed, pineapple skin, pineapple top, wheat bran, coffee husk, spent coffee ground, and barley bran.

22. The biodegradable disposable article of claim 1, or the method, of any one of the preceding claims, wherein the food waste has a moisture content of less than about 2%, or between 0.1% and about 1%.

23. The biodegradable disposable article of claim 1, wherein food waste comprises:
soluble carbohydrates comprising pectin in an amount of between about 1% and about 30%;
protein in an amount of between about 1% and about 20%; fat in an amount of between about 1% and about 15%.

24. The biodegradable disposable article of claim 1, wherein food waste comprises:
cellulose in an amount of between about 5% and about 25%;
soluble carbohydrates comprising pectin in an amount of between about 10% and about 30%;
protein in an amount of between about 1% and about 10%; fat in an amount of between about 1% and about 5%.

25. The biodegradable disposable article of claim 1, wherein food waste comprises:
cellulose in an amount of between about 5% and about 26%;
soluble carbohydrates comprising pectin in an amount of between about 1% and about 10%;
protein in an amount of between about 10% and about 20%; fat in an amount of between about 4% and about 11%.

26. A method of forming a biodegradable disposable article, the method comprising the steps of:
collecting unmodified and naturally occurring food waste comprising hemicellulose in an amount of less than about 60%, cellulose is present in a range between 5% and 30% and, less than 30 wt % soluble carbohydrate and at least about 2 wt % of lignin;
optionally heating and dehydrating the food waste to obtain dehydrated or dried food waste;
agitating or pulverizing the dried food waste to form particulate solid material having a particle size in the size range of 0.1 mm to 1 mm; and
placing said particulate solid material in a mould wherein the mould is subjected to a temperature of at least about 150° C. and applying pressure of at least 20 kg/cm² to the mould.
